(19) United States
(12) Patent Application Publication
(10) Pub. No.: US 2017/0262830 A1
(43) Pub. Date: Sep. 14, 2017

(54) RECEIPT PRINTING METHODS

(71) Applicant: Kingwelch Limited, Hong Kong (HK)

(72) Inventor: Shing Yi Li, Hong Kong (HK)

(73) Assignee: Bosany Env Limited, Kennedy Town (HK)

(21) Appl. No.: 15/063,653

(22) Filed: Mar. 8, 2016

(51) Int. Cl. G06Q 20/20; G06F 3/041; G06F 3/0354; G06K 15/16

(52) U.S. Cl. CPC G06Q 20/209; G06K 15/16; G06F 3/0412; G06F 3/03545

(57) ABSTRACT

According to embodiments of the disclosed technology, apparatuses and methods are provided for inputting & printing customized transaction information in real time on paper using a device. The method may facilitate user input of custom text and other data relating to an itemized purchase invoice. The user input may be carried out via an interactive display device or other electronic input device. The customized information may then be arranged and printed on the backside of a printed receipt and/or invoice received by the user pursuant to the transaction.

### FIELD OF THE INVENTION

The present invention generally relates to printing receipts, and more specifically relates to receiving customized information from a customer and printing underlying transaction information on paper using an electronic device in real time.

### BACKGROUND OF THE INVENTION

In a typical consumer transaction, buyers of goods and services receive receipts or invoices from sellers. A receipt may itemize a single product, but more often a receipt covers a plurality of items. This is more apparent in grocery shopping, in which as many as 50 or even 60 items may be purchased during a single visit to a store. When this happens, the invoice may result in a long list of items containing at least the names of the goods and services purchased as well as the price for each respective item.

To most consumers, after a purchase is made, the invoice is no longer important and is disposed unmindfully. Some would deem that it is too trivial to record and manage information concerning purchased items on a daily basis. Over time, the amount of information becomes exorbitant and it becomes too burdensome to keep track of transaction information that is seemingly scattered and unrelated.

Studies suggest that many consumers cannot recollect why purchases were made and some are even surprised to find the many items are found in their storages or cabinets at home and cannot explain what triggered these purchases. For example, a respondent may indicate that she was having difficulty remembering when a specific product in her cabinet was purchased. Interestingly, she could not remember why the purchase decision was made and what her rationale was for buying it at that time.

Another typical response may reveal that a buyer cannot remember the reason for buying an expensive box of chocolates—whether it was bought for himself to consume or as a gift for a relative or friend. They do have a common challenge—the list of items in their cabinets or storage keeps growing explicably. Therefore, it is desirable to provide means to collect information concerning a consumer's purchase at the time when the purchase is made, rather than after the purchase. Further, the means to collect the information needs to be done in a way that is efficient so that the purchase experience will not be disrupted. Still further, the information to be collected is desired to be collected structurally thereby allowing the consumer to fetch the information handily at a later time long after the purchase is made.

Point of sale systems are generally known in the prior art. Such systems are used to carry out and log information pertinent to a transaction. A POS system may typically include a main POS terminal/computer and cash drawer, and one or more standard peripheral devices (display monitor, payment processor with pinpad, receipt printer, barcode scanner, weigh scale, electronic signature pad).

Customized POS systems may have one or more of these peripheral devices integrated directly into the main POS terminal. Although POS systems are well equipped for merchants to monitor and collect transaction data from the POS system, the ability of the customer to input or extract useful information from the POS system is typically limited to pinpad interactions (entering tip amounts, obtaining additional cash back, etc.), and obtaining printed receipts, the format and content of which has been pre-determined by the merchant. As such, there exists a need for a consumer-customized receipt to be provided to customers in order to better archive and manage the plethora of items being purchased.

### SUMMARY OF THE INVENTION

According to embodiments of the invention, apparatuses and methods are provided for inputting & printing customized transaction information in real time on paper using a device. The method may facilitate user input of custom text and other data relating to an itemized purchase invoice. The user input may be carried out via an interactive display device or other electronic input device.

The customized information may then be arranged and printed on the backside of a printed receipt and/or invoice received by the user pursuant to the transaction.

In one embodiment of the disclosed technology, a method is provided for logging transaction information during a transaction for goods or services between a merchant and a consumer. The method may be carried out, not necessarily in the following order, by: a) receiving input information from a user through a display element having interactive capability, wherein the user defines the customized information and a defined area for the received input information to be displayed on a paper using the display element; b) printing, using a printing head, the transaction information on one side of the paper by feeding the paper through the printing head with a drive source for generating driving force to move the paper; c) printing the customized information on a side of the paper; and/or d) cutting the paper with the customized information and transaction information printed thereon using a blade arrangement.

The cutting mechanism may employ a fixed blade and a movable blade shiftable relative to the fixed blade. The removed portion is the customized invoice to be received by the consumer. The drive source may be a paper feed roller such as is found in printers.

In a further embodiment of the disclosed method, the step of receiving input information further includes previewing an expected output which compares the customized information in the defined area of the paper side by side with the transaction information on the display element. The user may make changes to the transaction information to be displayed on the display element.

The changes may include modifying the transaction information to be displayed on the display element. The transaction information may include a description of and price information of the goods. The added information may be text inputted by the user or handwritten notes written by the user by way of a stylus on a touch display. The method may further include printing the added separate information with respect to the each item associated to goods on a separate paper. The added separate information may include, for example, the date of purchase of the goods. In still further embodiments of the disclosed technology, the user may be allowed to add separate information with respect to each item using the display element.

In another embodiment of the disclosed technology, a method is provided for for inputting & printing customized transaction information in real time on paper using a device. The method may be carried out, not necessarily in the following order, by: a) receiving input information from a user through a display element with interactive capability, wherein the user defines the customized transaction information and a defined area for the received input information to be displayed on a second side of the paper through the display element; b) printing, using a printing head, the transaction information on a first side of the paper by moving the paper through the printing head with a drive source for generating driving force to move the paper; c) printing, through a second printing head, the customized transaction information on the second side of the paper; and/or d) cutting the paper with the printed customized information and transaction information using a blade mechanism employing a fixed blade and a movable blade shiftable relative to the fixed blade. Upon printing, a cutting blade mechanism, such as is typically found on receipt printers, cuts the relevant portion of the paper off. The cutting mechanism may employ a fixed blade and a movable blade shiftable relative to the fixed blade. The removed portion is the customized invoiced to be received by the consumer.

In a further embodiment, the step of receiving input information further may include previewing, in a side by side arrangement on the display, an expected output showing: i) the customized information in the defined area to be displayed on the second side of the paper; and ii) the transaction information to be shown on the first side of the paper through the display element. The user may be able to edit the transaction information to be displayed on the display element. The edits may include modifying the transaction information to be displayed on the display element. The transaction information may include, for example, a description of and price information regarding items included in the transaction.

A better understanding of the disclosed technology will be obtained from the following brief description of drawings illustrating exemplary embodiments of the disclosed technology.

### BRIEF DESCRIPTION OF THE DRAWINGS

FIG. 1 shows an invoice printer according to embodiments of the disclosed technology.

FIG. 2 shows a typical invoice or receipt as is generally known in the art.

FIG. 3 shows an invoice containing customized transaction information according to embodiments the disclosed technology.

FIG. 4 shows an invoice containing customized transaction information on both sides thereof according to embodiments the disclosed technology.

FIG. 5 shows a user navigating a display element with preview capability showing the customized information to be included on the invoice according to embodiments of the disclosed technology.

FIG. 6 shows a display element with preview capability showing the customized information to be included in the invoice according to embodiments of the disclosed technology.

FIG. 7 shows a display element with preview capability showing the customized information to be included on the backside of the invoice according to embodiments of the disclosed technology.

FIG. 8 shows a high-level block diagram of a microprocessor device that may be used to carry out the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

According to embodiments of the invention, apparatuses and methods are provided for inputting & printing customized transaction information in real time on paper using a device. The method may facilitate user input of custom text and other data relating to an itemized purchase invoice. The user input may be carried out via an interactive display device or other electronic input device. The customized information may then be arranged and printed on the backside of a printed receipt and/or invoice received by the user pursuant to the transaction.

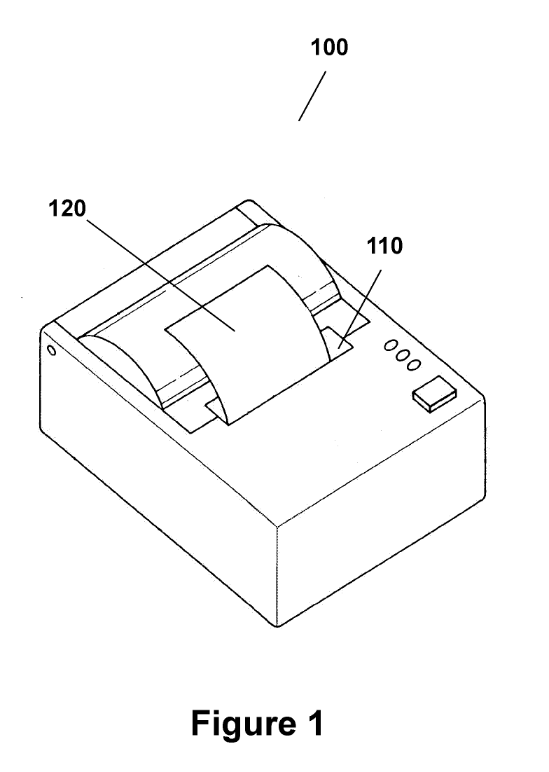

Referring now to FIG. 1, a flying object is depicted according to an embodiment of the disclosed technology. The depicted device 100 may be a “point of sale” (herein “POS”) system or a component thereof. Such systems are typically the facilitating point of a transaction. Point of sale systems have been customized to serve specific industries. Accordingly, merchants, retailers, service-providers, and restaurants use POS systems to process purchases by customers and to facilitate electronic record keeping for their business. For example, a merchant may use a POS system to generate accounting reports, employee records, sales reports, track inventory, calculate cost/profit ratios, and the like. The

POS system may further be programmed by the merchant to automatically or manually authorize specific discounts, and to authorize returns or exchanges.

A POS system may typically include a main POS terminal/computer and cash drawer, and one or more standard peripheral devices (display monitor, payment processor with pinpad, receipt printer, barcode scanner, weigh scale, electronic signature pad). Customized POS systems may have one or more of these peripheral devices integrated directly into the main POS terminal. The POS system may, as depicted, include a printing head or printer 110 for printing a physical receipt on paper 120. The paper 120 may be fed through the printing head 110 using one or more internal rollers stored within the device.

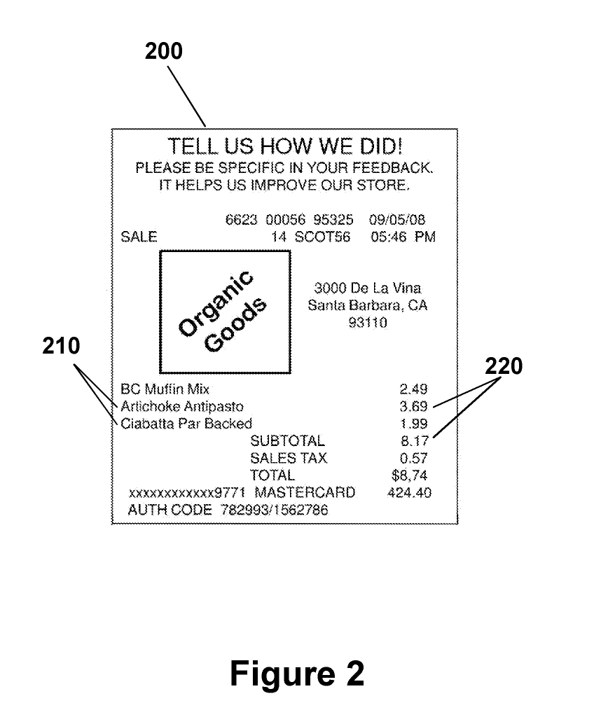

FIG. 2 shows a typical invoice or receipt as is generally known in the art. The invoice 200 is typical of a receipt or invoice typically provided to a consumer pursuant to a transaction. The invoice 200 contains standardized information pertinent to the transaction. This information is typically set by the retailer. The information may include item names 210 and prices 220, as dictated by the retailer.

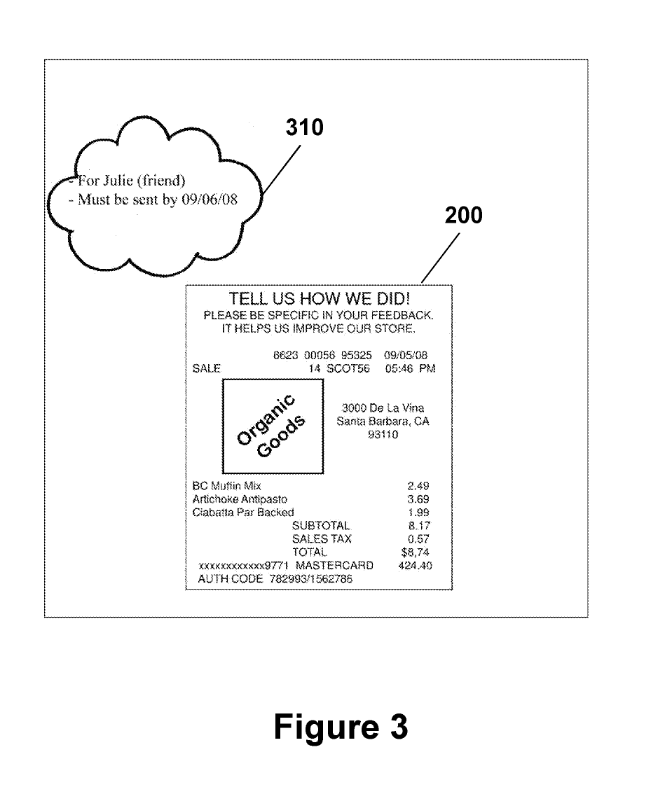

FIG. 3 shows an invoice containing customized transaction information according to embodiments the disclosed technology. The customized information 310 is, in this example, a note regarding the purchased items being sent to a friend by a certain date. Such information may be inputted and prescribed by the purchasing consumer. The information, while minute, may greatly help the customer to keep track of the purchase and stay organized with respect to the purchased items as well as the pertinent dates and people to whom those items concern.

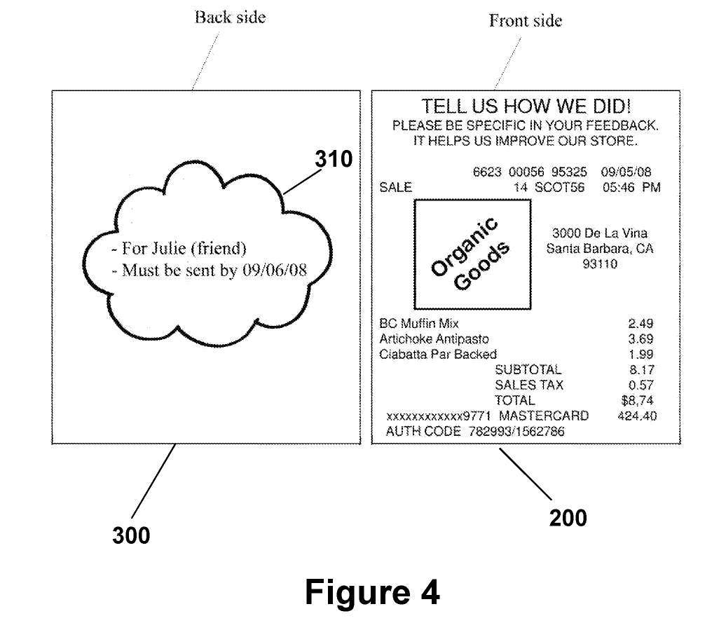

FIG. 4 shows an invoice containing customized transaction information on both sides thereof according to embodiments the disclosed technology. As shown, the custom information 310 inputted by the customer is printed on a back side 300 of the invoice. The front side 200 of the invoice contains the standardized information already found on a typical receipt or invoice. Since the custom information 310 is printed on the back of the receipt, no additional paper is needed. This helps the environment while reducing clutter and keeping the customer organized.

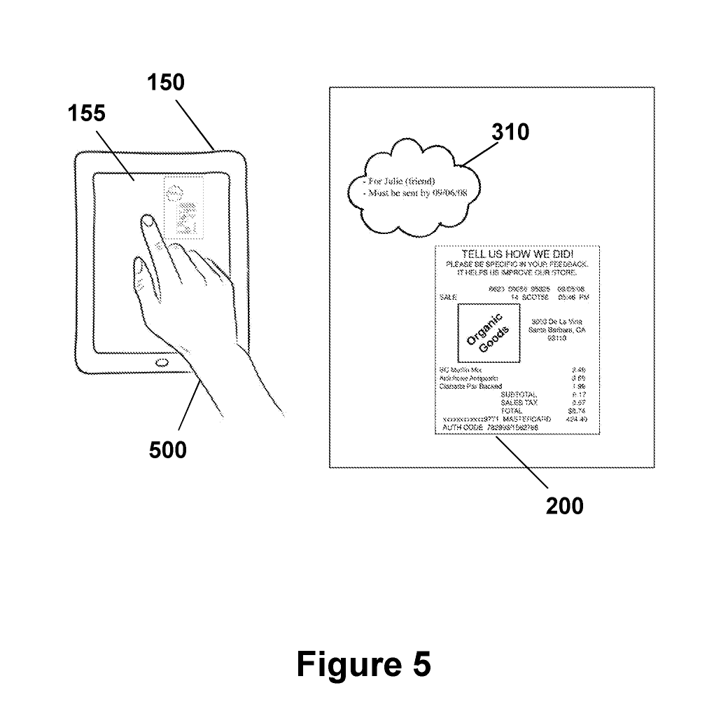

FIG. 5 shows a user navigating a display element with preview capability showing the customized information to be included on the invoice according to embodiments of the disclosed technology. The display element 150 may be any electronic device with a screen 155 capable of displaying visualizations. The display element 150 may be associated with or a component of the POS system. Alternatively, the display element 150 may be separate and distinct from the POS system, and may merely communicate with the POS system during the transaction. For example, the display element 150 may be a touch screen or a tablet computer capable of receiving touch inputs from a consumer 500.

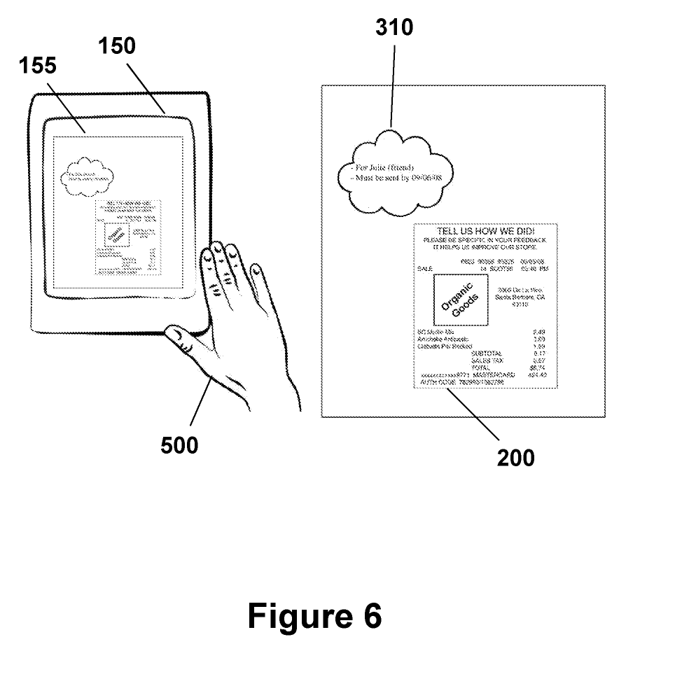

FIG. 6 shows a display element with preview capability showing the customized information to be included in the invoice according to embodiments of the disclosed technology. As depicted, the consumer 500 may dictate the configuration, layout, and text of the customized portion or side of the invoice 200. This may all be carried out on the screen 155 of the display 150

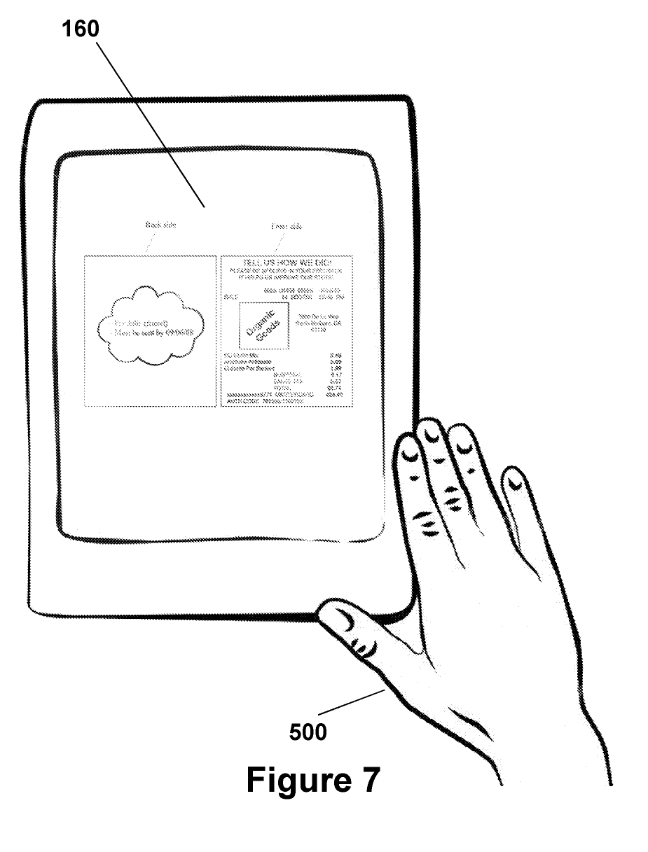

FIG. 7 shows a display element with preview capability showing the customized information to be included on the backside of the invoice according to embodiments of the disclosed technology. This figure shows a print-preview 160 of the final version of the invoice to be printed. Upon confirmation by the user, the physical invoice may be printed on both sides of a portion of rolled paper. Upon printing, a cutting blade mechanism, such as is typically found on receipt printers, cuts the relevant portion of the paper off. The cutting mechanism may employ a fixed blade and a movable blade shiftable relative to the fixed blade. The removed portion is the customized invoiced to be received by the consumer 500.

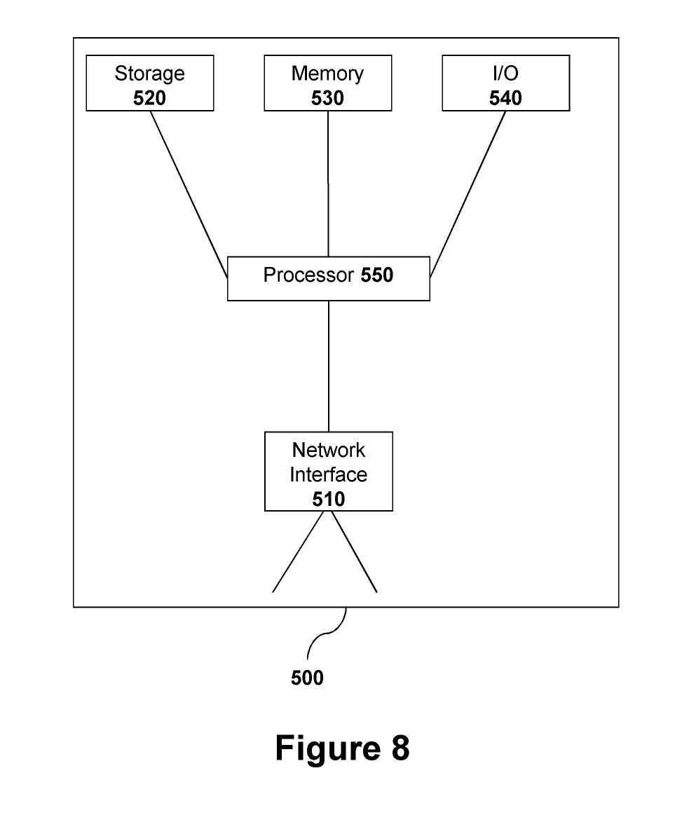

FIG. 8 is a high-level block diagram of a microprocessor device that may be used to carry out the disclosed technology. The device 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

One skilled in the art will recognize that an implementation of an actual device will contain other components as well, and that FIG. 3 is a high level representation of some of the components of such a device for illustrative purposes. It should also be understood by one skilled in the art that the method and devices depicted in FIGS. 1 through 7 may be implemented on a device such as is shown in FIG. 8.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mutt,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings).

Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

What is claimed:

1. A method for logging transaction information, comprising:
receiving input information from a user through a display element having interactive capability, wherein the user defines the customized information and a defined area for the received input information to be displayed on a paper using the display element;
printing, using a printing head, the transaction information on one side of the paper by feeding the paper through the printing head with a drive source for generating driving force to move the paper;
printing the customized information on a side of the paper; and
cutting the paper with the customized information and transaction information printed thereon using a blade arrangement.

2. The method of claim 1, where in the blade arrangement employs a movable blade shiftable with respective to a fixed blade.

3. The method of claim 1, wherein the drive source is a paper feed roller.

4. The method of claim 1, wherein the step of receiving input information further includes previewing an expected output which compares the customized information in the defined area of the paper side by side with the transaction information on the display element.

5. The method of claim 4, wherein the user makes changes to the transaction information to be displayed on the display element.

6. The method of claim 5, wherein the changes include modifying the transaction information to be displayed on the display element.

7. The method of claim 6, wherein the transaction information includes a description of and price information of the goods.

8. The method of claim 4, wherein the user adds separate information with respect to each item using the display element.

9. The method of claim 8, wherein the added information is text.

10. The method of claim 8, wherein the added information is recorded using a stylus pressed against a touch element associated with the display.

11. The method of claim 7, wherein the method further includes printing the added separate information with respect to the each item associated to goods on a separate paper, wherein the added separate information includes date of purchase of the goods.

12. A method for inputting & printing customized transaction information in real time on paper using a device, comprising:
receiving input information from a user through a display element with interactive capability, wherein the user defines the customized transaction information and a defined area for the received input information to be displayed on a second side of the paper through the display element;
printing, using a printing head, the transaction information on a first side of the paper by moving the paper through the printing head with a drive source for generating driving force to move the paper;
printing, through a second printing head, the customized transaction information on the second side of the paper; and
cutting the paper with the printed customized information and transaction information using a blade mechanism employing a fixed blade and a movable blade shiftable relative to the fixed blade.

13. The method of claim 12, wherein the drive source is a paper feed roller.

14. The method of claim 13, wherein the step of receiving input information further includes previewing, in a side by side arrangement on the display, an expected output showing:
i) the customized information in the defined area to be displayed on the second side of the paper; and
ii) the transaction information to be shown on the first side of the paper through the display element.

15. The method of claim 14, wherein the user edits the transaction information to be displayed on the display element.

16. The method of claim 15, wherein the edits include modifying the transaction information to be displayed on the display element.

17. The method of claim 16, wherein the transaction information includes a description of and price information regarding items included in the transaction.
